(19) United States
(12) Patent Application Publication
(10) Pub. No.: US 2007/0050731 A1
(43) Pub. Date: Mar. 1, 2007

(54) Pull down menu displays

(75) Inventors: Albert Dehjay Bennah, Durham, NC (US); Sergio A. Hernandez, Durham, NC (US); William Gabriel Pagan, Durham, NC (US)

Correspondence Address: IBM CORPORATION, PO BOX 12195, DEPT YXSA, BLDG 002, RESEARCH TRIANGLE PARK, NC, 27709, US

(73) Assignee: International Business Machines Corporation, Armonk, NY (US)

(21) Appl. No.: 11/212,452

(22) Filed: Aug. 26, 2005

(51) Int. Cl. G06F 9/00

(52) U.S. Cl. 715/810; 715/856; 715/835

(57) ABSTRACT

In order to facilitate the use of pull down menu functions by users who may experience difficulty in maintaining cursor position within such a menu while displayed, an option is provided to enable such a user to make a pull down menu “sticky”, in the sense that menu collapse is less sensitive or insensitive to cursor movement away from the bounds of the menu. That is, cursor movement away from the bounds of the pull down menu allows the menu to continue to be displayed, allowing time for the user to correctly position the cursor to access a desired function from the pull down menu.

### FIELD AND BACKGROUND OF INVENTION

This invention relates to pull down menu displays on computer systems and adaptation of those displays to accommodate user impairments which would otherwise interfere with the usefulness of such menus.

Most computer users have become familiar with, and use, pull down menus. Such menus are typically provided in application programs such as word processing, spread sheet and graphics programs. The functionality is supported by operating systems software which provides the display desktop on which application program work spaces are displayed. Typically, an application program work space includes a toolbar defining a series of functions, such as “File, Edit, View, Insert” etc. Each of these functions has a related pull down menu of more specific functions. The pull down menus are displayed by positioning a cursor, controlled by a pointing device input such as from a mouse, over the toolbar function. On a user positioning the cursor in this manner, the pull down menu appears and the user is presented with options to select further functions. In supporting this functionality, the application program calls on supporting services from the operating system software.

In the default operation provided by operating system vendors, pull down menus for a series of toolbar functions drop and collapse or disappear as a cursor is moved along the toolbar. That is, should the cursor be positioned over the “File” toolbar indicator, then the related pull down menu appears. Should the cursor be moved from the “File” indicator to the adjacent “Edit” indicator, the File pull down menu collapses and the pull down menu related to the Edit function appears. Skilled users can quickly manipulate a cursor to move among the available pull down menus and select functions to be executed.

However, this collapse and drop function presents difficulty for some users. In particular, a user with some motor impairment may not be able to maintain cursor position within a pull down menu so as to select a secondary function. Such as user may be unable to prevent the cursor position from wandering onto an adjacent toolbar indicator, causing the desired pull down menu to collapse and an alternate menu to appear before the desired function can be selected. Thus the default operation selected by operating system software designers presents a difficulty which has not previously been addressed.

The same problem may be presented by certain environments. For example, the small screen of a palm top system may provide difficulty for a person of normal manual dexterity. Additionally, software and hardware problems with a conventional system, such as a drifting touchpad or pointing stick cursor or a dirty mouse having that effect may cause a cursor to drift uncontrollably away from a selected menu.

### SUMMARY OF THE INVENTION

With the foregoing in mind, it is a purpose of this invention to facilitate the use of pull down menu functions by users who may experience difficulty—for whatever reason—in maintaining cursor position within such a menu while displayed. In realizing this purpose, an option is provided to enable such a user to make a pull down menu “sticky”, in the sense that menu collapse is less sensitive or insensitive to cursor movement away from the bounds of the menu. That is, cursor movement away from the bounds of the pull down menu allows the menu to continue to be displayed, allowing time for the user to correctly position the cursor to access a desired function from the pull down menu.

### BRIEF DESCRIPTION OF DRAWINGS

Some of the purposes of the invention having been stated, others will appear as the description proceeds, when taken in connection with the accompanying drawings, in which:

FIG. 1 is an elevation view of a computer system;

FIG. 2 is a schematic representation of a work space display on the system of FIG. 1;

FIGS. 3 and 4 are views similar to FIG. 2; and

FIG. 5 shows a computer readable media.

### DETAILED DESCRIPTION OF INVENTION

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

The present invention may be implemented in a computer system, in a method of operating a computer system, and in the form of a program product distributed for use in a computer system.

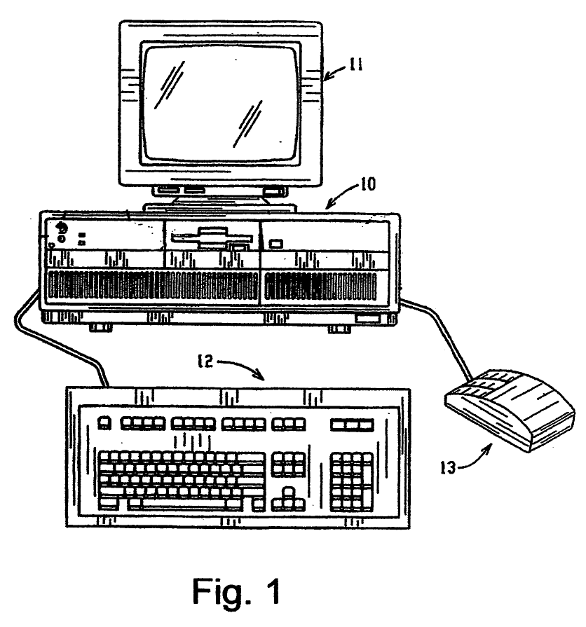

Turning first to implementation in a computer system, FIG. 1 illustrates a typical computer workstation, here a personal computer system 10. The system includes a central processor, memory accessible to the processor for storing data including programs to be executed, a display 11, and input devices including a keyboard 12 and a pointing device (here shown as a mouse 13). Such computer systems come in a variety of configurations, some known as notebook systems, others as desktop or deskside systems, some known as servers, and some known as “thin clients”. The present invention finds usefulness with any such systems, and it is to be understood that the choice of one type of such system for illustration is in no way limiting upon the implementation of this invention. Persons familiar with the arts of computer technology will easily recognize the scope of applicability of what is here described and illustrated.

It should be noted that a variety of pointing devices may be used with such a system. These can include a mouse (wired or wireless), a pointing stick such as a Trackpoint, a touch pad, a trackball and possibly other types of devices. Reference is made herein to a control signal originating from a pointing device as a “mouse click”, as that terminology has become well known. Notwithstanding that usage, it is to be understood that the control signal may be originated from the other types of pointing devices, as provision is always made with such devices for at least two control signals, conventionally known as a “left click” and a “right click” from the positioning of the relevant switches on a classic wired mouse.

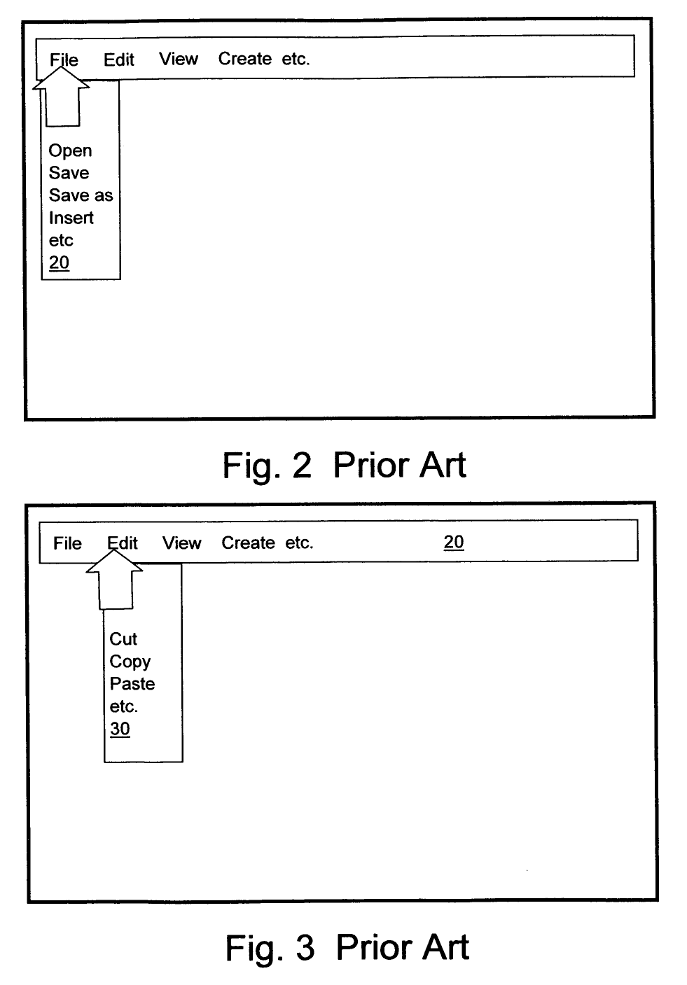

The system 10, as suggested, includes a monitor or display 11, on which information relevant to the operation of the system appears for the user. FIGS. 2 and 3 show views of what appears on the display 11 during use of this invention. Each of FIGS. 2 and 3 shows what has come to be called the “Work space” of the system while executing an application program. Typically, and while running under a range of operating systems including for example only and not be way of limitation Microsoft Windows, Linux, Unix, OS/2 and others and a similar range of application programs such as word processing, spreadsheet and graphics programs, the work space displays to a user a toolbar, representing program functions accessible to a user. In most operating systems and application programs in general use, such a starting signal is a mouse click, performed by depressing a switch provided on the mouse 13. While described herein, this operation is generally known and widely used in current computer system operations.

More particularly, and as is demonstrable on most personal computer systems, positioning a cursor over an item in an application program toolbar, such as the item “File”, and executing a mouse click will cause a menu to appear below the toolbar item, know as a “drop down menu”. Such a menu is illustrated in FIG. 2 at 20. The illustrated form is somewhat abbreviated, as the drop down menu may be of some length, determined by the software designer, but is sufficient for illustrating the principles of this invention. FIG. 2 illustrates essentially the known prior art. As is known to skilled users of computer systems, the content of toolbars and of drop down menus is generally determined by a software designer, although some applications may give a user some freedoms in selecting toolbars or their contents or drop down menus or their contents.

Once a drop down menu has been displayed from a first toolbar item, conventional practice allows a user to move the cursor across the toolbar and cause successive drop down menus to be displayed as the cursor traverses along the toolbar. This is illustrated in FIG. 3, when the cursor has been moved along the toolbar to the item “Edit” and an abbreviated form of a conventional drop down menu is shown at 30. This prior art characteristic presents precisely the problem overcome by the present invention. The same effect of dropping down an adjacent menu will arise from small motor control difficulties and from the difficulties mentioned above as affecting small or troubled systems.

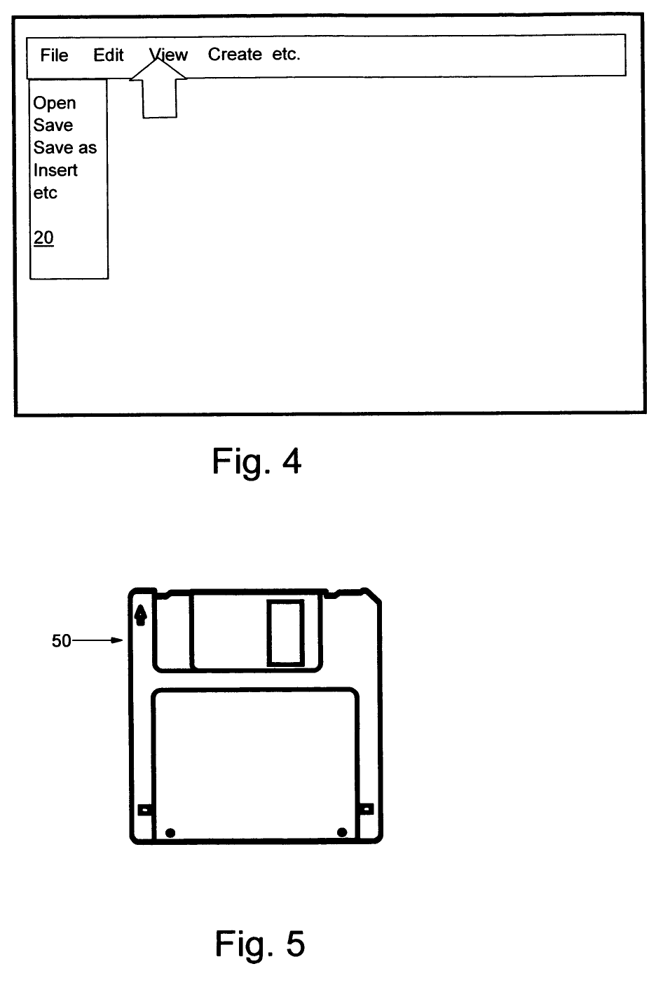

FIG. 4 illustrates the solution of this invention. That is, the cursor has been moved, intentionally or otherwise, from the toolbar item “File” to the toolbar item “View”. However, rather than responding by displaying the relevant drop down menu, the cooperation of the operating system and the application program has caused the drop down menu for the “File” item to continue to be displayed. This is intentional, as providing fro the drop down menu display to persist for an interval of time.

The present invention contemplates that a user be given the choice between the prior art characteristic display of FIGS. 2 and 3 and the inventive characteristic display of FIGS. 2 and 4. That is, this invention provides a method in which there is a: display of an application program controlled work space enabling cursor control of pull down menus; and the system responds to movement of a cursor away from a displayed pull down menu in a selected one of two characteristic ways. The two ways are a first response to cursor movement away from the menu which causes the menu display to collapse; and a second response to cursor movement away from the menu which causes the menu display to persist. A user may select which of the two responses is to be effective in the application program. The second response will cause the displayed pull down menu to persist for a predetermined interval of time after which the menu display is caused to collapse. The user selecting the second characteristic response may select the interval of time during which the second response causes the displayed pull down menu to persist. Optionally, selection of the second response causes the suppression of all other pull down menus during the interval that the displayed pull down menu is caused to persist.

As will be understood, enabling such operation involves producing computer executable program code; and providing the program code to be deployed to and executed on a computer system. The program code provides instructions which causes the display of an application program controlled work space enabling cursor control of pull down menus, and responds to movement of a cursor away from a displayed pull down menu in a selected one of the two characteristic ways described above.

Further, an apparatus enabled to practice this invention has a computer system; and computer executable code stored accessibly to and executing on said computer system. The code when executing, displays an application program controlled work space enabling cursor control of pull down menus and responds to movement of a cursor away from a displayed pull down menu in a selected one of the two characteristic ways described above.

FIG. 5 shows a computer readable medium, in the form of a diskette 50, which carries computer executable code stored on said media accessibly to and executable on a computer system. The code, when executing, displays an application program controlled work space enabling cursor control of pull down menus and responds to movement of a cursor away from a displayed pull down menu in a selected one of the two characteristic ways described above.

In the drawings and specifications there has been set forth a preferred embodiment of the invention and, although specific terms are used, the description thus given uses terminology in a generic and descriptive sense only and not for purposes of limitation.

What is claimed is:

1. Method comprising:
displaying an application program controlled work space enabling cursor control of pull down menus; and
responding to movement of a cursor away from a displayed pull down menu in a selected one of two characteristic ways;
a first response to cursor movement away from the menu causing the menu display to collapse; and
a second response to cursor movement away from the menu causing the menu display to persist.

2. Method according to claim 1 further comprising selecting which of the two responses is to be effective in the application program.

3. Method according to claim 1 wherein the second response causes the displayed pull down menu to persist for a predetermined interval of time after which the menu display is caused to collapse.

4. Method according to claim 3 further comprising selecting the interval of time during which the second response causes the displayed pull down menu to persist.

5. Method according to claim 1 further comprising suppressing all other pull down menus during the interval that the displayed pull down menu is caused to persist.

6. Method comprising:
producing computer executable program code; and
providing the program code to be deployed to and executed on a computer system;
the program code providing instructions which:
displays an application program controlled work space enabling cursor control of pull down menus; and
responds to movement of a cursor away from a displayed pull down menu in a selected one of two characteristic ways;
a first response to cursor movement away from the menu causing the menu display to collapse; and
a second response to cursor movement away from the menu causing the menu display to persist.

7. Method according to claim 6 in which the program code instructions enable selecting which of the two responses is to be effective in the application program.

8. Method according to claim 6 wherein the second response causes the displayed pull down menu to persist for a predetermined interval of time after which the menu display is caused to collapse.

9. Method according to claim 8 in which the program code instructions enable selecting the interval of time during which the second response causes the displayed pull down menu to persist.

10. Method according to claim 6 in which the program code instructions suppress all other pull down menus during the interval that the displayed pull down menu is caused to persist.

11. Apparatus comprising:
a computer system; and
computer executable code stored accessibly to and executing on said computer system, said code when executing:
displaying an application program controlled work space enabling cursor control of pull down menus; and
responding to movement of a cursor away from a displayed pull down menu in a selected one of two characteristic ways;
a first response to cursor movement away from the menu causing the menu display to collapse; and
a second response to cursor movement away from the menu causing the menu display to persist.

12. Apparatus according to claim 11 in which said computer executable code enables selecting which of the two responses is to be effective in the application program.

13. Apparatus according to claim 11 wherein the second response causes the displayed pull down menu to persist for a predetermined interval of time after which the menu display is caused to collapse.

14. Apparatus according to claim 13 in which said computer executable code enables selecting the interval of time during which the second response causes the displayed pull down menu to persist.

15. Apparatus according to claim 11 in which said computer executable code suppresses all other pull down menus during the interval that the displayed pull down menu is caused to persist.

16. A program product comprising:
computer readable media;
computer executable code stored on said media accessibly to and executable on a computer system, said code when executing:
displaying an application program controlled work space enabling cursor control of pull down menus; and
responding to movement of a cursor away from a displayed pull down menu in a selected one of two characteristic ways;
a first response to cursor movement away from the menu causing the menu display to collapse; and
a second response to cursor movement away from the menu causing the menu display to persist.

17. Program product according to claim 16 in which said computer executable code enables selecting which of the two responses is to be effective in the application program.

18. Program product according to claim 16 wherein the second response causes the displayed pull down menu to persist for a predetermined interval of time after which the menu display is caused to collapse.

19. Program product according to claim 18 in which said computer executable code enables selecting the interval of time during which the second response causes the displayed pull down menu to persist.

20. Program product according to claim 16 in which said computer executable code suppresses all other pull down menus during the interval that the displayed pull down menu is caused to persist.
